(19) United States
(12) Patent Application Publication
(10) Pub. No.: US 2021/0302258 A1
(43) Pub. Date: Sep. 30, 2021

(54) System and Method for Customization of Wheel and Tire Assembly Balancing

(71) Applicant: Ford Global Technologies, LLC, Dearborn, MI (US)

(72) Inventors: Neal Koenig, New Hudson, MI (US); Robert Camilleri, Grosse Ile, MI (US); Daniel Ostrowski, Milan, MI (US)

(21) Appl. No.: 16/834,298

(22) Filed: Mar. 30, 2020

(51) Int. Cl. G01M 1/02; G01M 1/22

(52) U.S. Cl. CPC G01M 1/02; G01M 1/225

(57) ABSTRACT

A method of determining a balancing solution for a rotating body that includes a wheel or wheel/tire assembly may include receiving balance parameters defining measured imbalance associated with the rotating body and receiving a set of constraints. At least one of the constraints may define a non-zero target correction of one of the balance parameters. The method may further include determining, via a selected optimization strategy, the balancing solution defining a correction to apply to the rotating body to achieve corrected balance parameters meeting the set of constraints.

### TECHNICAL FIELD

Example embodiments generally relate to balancing of wheel and tire assemblies and, more particularly, relate to a system and method for enabling full customization of wheel and tire assembly balancing.

### BACKGROUND

Proper wheel or tire assembly balance can be a significant factor in maximizing fuel efficiency in vehicles, and in relation to customer satisfaction based on reduced vibration while driving. Thus, a number of tools and methodologies have been developed to facilitate improved balancing efforts. That said, current industry solutions for tools and methods associated with balancing of wheel and tire assemblies only function to minimize static and couple imbalance, or minimize the weight used in balancing. This results in a rigid balancing paradigm that may not be capable of producing optimal balancing solutions across a wide range of different sizes of wheels and tire assemblies or allow flexibility based on vehicle architecture.

Thus, it may be desirable to develop improved methods and tools for balancing wheel and tire assemblies that are both less rigid, and also provide improved results.

### BRIEF SUMMARY OF SOME EXAMPLES

In accordance with an example embodiment, a method of determining a balancing solution for a rotating body that includes a wheel or wheel assembly may be provided. The method may include receiving balance parameters defining measured imbalance associated with the rotating body and receiving a set of constraints. At least one of the constraints may define a non-zero target correction of one of the balance parameters. The method may further include determining, via a selected optimization strategy, the balancing solution defining a correction to apply to the rotating body to achieve corrected balance parameters meeting the set of constraints.

In another example embodiment, a balance controller for determining a balancing solution for a rotating body that includes a wheel or wheel assembly may be provided. The balance controller may include processing circuitry configured for receiving balance parameters defining measured imbalance associated with the rotating body and receiving a set of constraints. At least one of the constraints may define a non-zero target correction of one of the balance parameters. The processing circuitry may be further configured for determining, via a selected optimization strategy, the balancing solution defining a correction to apply to the rotating body to achieve corrected balance parameters meeting the set of constraints.

In yet example embodiment, a balancing system for determining a balancing solution for a rotating body that includes a wheel or wheel assembly may be provided. The balancing system may include a balance controller that may include processing circuitry configured for receiving balance parameters defining measured imbalance associated with the rotating body and receiving a set of constraints. At least one of the constraints may define a non-zero target correction of one of the balance parameters. The processing circuitry may be further configured for determining, via a selected optimization strategy, the balancing solution defining a correction to apply to the rotating body to achieve corrected balance parameters meeting the set of constraints.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a balancing system in accordance with an example embodiment;

FIG. 2 illustrates a process flow associated with operation of a balancing module according to an example embodiment;

FIG. 3 illustrates an example interface screen that may be used for interface with the balance module of an example embodiment;

FIG. 4 illustrates an example in which an algorithm selector operates as a menu of selectable options for predefined algorithms in accordance with an example embodiment;

FIG. 5 illustrates an interface screen for a given set of data provided as balance parameters that are unable to determine a balance solution based on the constraints given in accordance with an example embodiment;

FIG. 6 illustrates a change to the constraints to enable arriving at the balance solution in accordance with an example embodiment;

FIG. 7 illustrates another potential modification to the constraints and/or the selected algorithm to enable arriving at the balance solution in accordance with an example embodiment; and

FIG. 8 illustrates a block diagram of a method of determining balancing adjustments for a rotating body in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Larger wheel and tire assemblies inherently have larger rotating mass and moments of inertia. The more massive a tire or wheel, the larger the probability that the center of gravity will not exist on the center of rotation. When the center of gravity of an assembly does not fall on the axis of rotation, rotational imbalance is created in the form of static imbalance or couple imbalance. As noted above, current wheel and tire assembly balancing methodologies have rigid limits imposed such as targeting zero residual static imbalance and zero couple imbalance. The amount of weight, and the placement of that weight, is an output of the balance equations used in this rigidly constructed system. Thus, it is not possible to target a different setpoint for balance, or to perform tuned balancing in accordance with customer desires.

Some example embodiments described herein may address the problems described above. In this regard, for example, some example embodiments may provide an improved system and methodology for balancing wheel assemblies or components thereof. As a result, vehicle efficiency, assembly plant throughput and driver experience/satisfaction may also be improved.

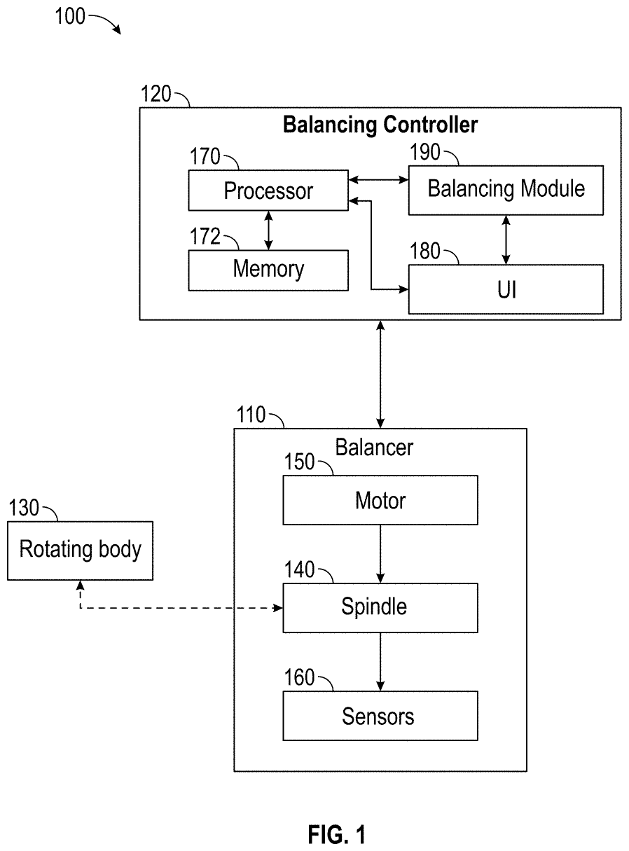

FIG. 1 illustrates a block diagram of a balancing system 100 of an example embodiment. The balancing system 100 may include a balancer 110 and a balancing controller 120. The balancer 110 may include a number of physical components and may be operably coupled to a rotating body 130 (e.g., a wheel rim or wheel assembly including a wheel rim and a tire installed thereon) to facilitate rotation of the rotating body 130 and the determination of various characteristics of the rotating body 130 that relate to making balancing determinations. Meanwhile, the balancing controller 120 may be operably coupled to the balancer 110 to receive information useful in making balancing determinations and/or directing adjustments that can be implemented by adding weights to selected locations on the rotating body 130.

In this regard, the balancer 110 may include a spindle 140 to which the rotating body 130 is physically attached, and the spindle 140 may be operably coupled to a motor 150 that provides the motive force to turn the spindle 140 and thereby also rotate the rotating body 130. The balancer 110 may also include one or more sensors 160 that are configured to sense vibrations generated during rotation of the rotating body 130. The vibrations may be produced due to imbalance in the rotating body 130 and thus, by analyzing the vibrations detected by the sensors 160, it may be possible to implement balance corrections (e.g., by adding weights to the rotating body 130) that adjust the amount or nature of the imbalance.

In an example embodiment, the output of the sensors 160 may be provided to the balancing controller 120, which may be configured to determine characteristics or parameters associated with the imbalance of the rotating body 130 (i.e., balance parameters defining at least couple imbalance and static imbalance for the rotating body 130) based on the vibrations detected. The balancing controller 120 may therefore be configured to employ balancing equations or other software or application-based tools to determine, based on the balance parameters, an amount of, and location for, placement of weights that may provide the balance corrections. The balance correction may be part of a balance solution described in greater detail below. However, the balancing controller 120 may also be configured to enable solution tuning (e.g., tuning of the balance solution) in ways not previously possible. Accordingly, for example, the balancing controller 120 may be able to receive numerous different parameters, indications and other information that may be related to or indicative of different inputs or conditions associated with balancing of wheel rims or wheel assemblies. The balancing controller 120 may be configured to use the information received in association with the execution of one or more control algorithms (which may themselves also be selectable) that may be used to generate solutions for balancing of the rotating body 130. The balancing controller 120 may also provide control over the operation of the balancer 110 (e.g., providing motor control inputs for the motor 150), and may enable a user or operator to interface with the system 100 in order to achieve desired outcomes as described herein.

As shown in FIG. 1, the balancing controller 120 may include processing circuitry (e.g., processor 170 and memory 172) that is configurable to perform data processing as described herein. As such, for example, the balancing controller 120 may include (or otherwise have access to) memory (e.g., the memory 172) for storing instructions or applications for the performance of various functions and a corresponding processor (e.g., processor 170) for executing stored instructions or applications. The balancing controller 120 may also include software and/or corresponding hardware for enabling the performance of the respective functions of the balancing controller 120 including, for example, the receipt of balance parameters, execution of various balancing equations and/or algorithms associated with processing of the balance parameters and the generation of various content or outputs for review or consideration by an operator or user.

In one embodiment, the processing circuitry (e.g., the processor 170 and memory 172) may be in communication with or otherwise control a user interface 180 and a balancing module 190. As such, the processing circuitry may be embodied as a circuit chip (e.g., an integrated circuit chip) configured (e.g., with hardware, software or a combination of hardware and software) to perform operations described herein. Thus, for example, the processing circuitry may be embodied as a portion of a server, computer, laptop, workstation or even one of various mobile computing devices.

The user interface 180 may be in communication with the processing circuitry to receive an indication of a user input at the user interface 180 and/or to provide an audible, visual, mechanical or other output to the user. As such, the user interface 180 may include, for example, a keyboard, a mouse, a joystick, a display, a touch screen, a microphone, a speaker, or other input/output mechanisms. In some cases, the user interface 180 may also include a series of web pages or interface consoles generated to guide the user through various options, commands, flow paths and/or the like for control of or interaction with the balancing module 190.

In an example embodiment, the memory 172 may include one or more non-transitory storage or memory devices such as, for example, volatile and/or non-volatile memory that may be either fixed or removable. The memory 172 may be configured to store information, data, applications, instructions or the like for enabling the apparatus to carry out various functions in accordance with example embodiments of the present invention. For example, the memory 172 could be configured to buffer input data for processing by the processor 170. Additionally or alternatively, the memory 172 could be configured to store instructions for execution by the processor 170. As yet another option, the memory 172 may include one of a plurality of databases that may store a variety of files, contents or data sets, or structures used to enable balance equation calculations associated with operation of the balance module 190. Among the contents of the memory 172, applications may be stored for execution by the processor 170 in order to carry out the functionality associated with each respective application.

The processor 170 may be embodied in a number of different ways. For example, the processor 170 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 170 may be configured to execute instructions stored in the memory 172 or otherwise accessible to the processor 170. As such, whether configured by hardware or software methods, or by a combination thereof, the processor 170 may represent an entity (e.g., physically embodied in circuitry) capable of performing operations according to embodiments of the present invention while configured accordingly. Thus, for example, when the processor 170 is embodied as an ASIC, FPGA or the like, the processor 170 may be specifically configured hardware for conducting the operations described herein. Alternatively, as another example, when the processor 170 is embodied as an executor of software instructions, the instructions may specifically configure the processor 170 to perform the operations described herein.

In an example embodiment, the processor 170 (or the processing circuitry) may be embodied as, include or otherwise control the balancing module 190, which may be any means such as a device or circuitry operating in accordance with software or otherwise embodied in hardware or a combination of hardware and software (e.g., processor 170 operating under software control, the processor 170 embodied as an ASIC or FPGA specifically configured to perform the operations described herein, or a combination thereof) thereby configuring the device or circuitry to perform the corresponding functions of the balancing module 190 as described herein.

Although FIG. 1 shows the balancing system 100 to include the balancer 110 and the balancing controller 120 in a connected fashion, it should be appreciated that balancing module 190 may also be instantiated at a device separate from the balancing controller 120. Thus, for example, the balancing module 190 could be implemented on a computer or analysis terminal that is separated from the balancer 110, but may have balance parameters provided thereto either in real time or from stored data after the fact. Thus, for example, the balancing controller 120 could be a typical machine controller of the balancer 110, and the balancing module 190 (and processing circuitry associated therewith) may either also be instantiated at the balancer 110 or on a separate computer. A balance controller of an example embodiment may therefore include any combination of processing circuitry located locally at or remote from the balancer 110, and include any combination of machine controls, physical hardware and/or software associated with all such components shown in FIG. 1.

As noted above, conventional balancing equations and paradigms typically target zero for static and couple imbalance. Thus, conventional balancing questions and paradigms effectively only have a single optimization algorithm (i.e., one that targets zero for static and couple imbalance). Although a tolerance may be defined (e.g., 18 grams (g) of static imbalance and 22 g of couple imbalance) relative to the target, the rigid definition of the zero target may nevertheless not be avoided. Moreover, even the tolerance allowed cannot be changed on either a per plant or per part basis. In other words, the system constraints used for determining balance solutions are typically also fixed and not variable. Thus, the conventional balancing equations are relatively restricted in their ability to generate solutions in some cases.

The balancing module 190 of example embodiments may be configured to allow for targeting of a different setpoint for balance or tuning (i.e., not zero). In other words, the balancing module 190 may be configured to allow the user or operator to generate a variable solution set based on variable inputs and variable constraints that were not possible with prior solutions. Thus, for example, the customer or designer can target other acceptable or desirable setpoints, which can make a whole range of solutions that were previously not possible to achieve open to possibility. More flexible tuning may therefore also be possible using the balancing module 190 of example embodiments.

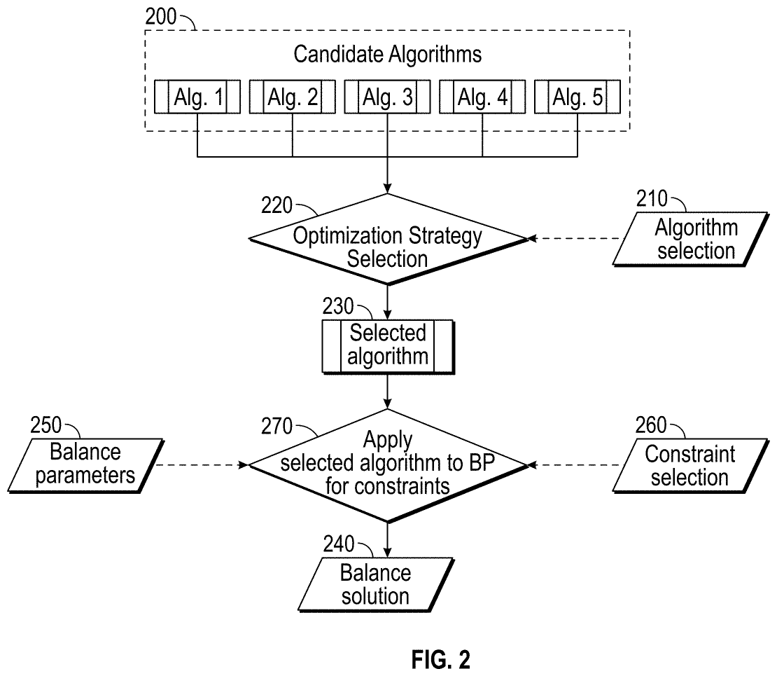

In an example embodiment, the balancing module 190 may be configured to accept a set of inputs and constraints that are selectable by the operator, and to accept selection of specific optimization strategies that are made possible by breaking the rigid reliance on a zero target for static and couple imbalance. FIG. 2 illustrates a process flow associated with operation of the balancing module 190 according to an example embodiment. In this regard, as shown in FIG. 2, a plurality of algorithms may be stored (e.g., in the memory 172) as candidate algorithms 200. Each of the algorithms among the candidate algorithms 200 (e.g., algorithm 1, algorithm 2, algorithm 3, algorithm 4 and algorithm 5) may include a corresponding set of balance equations configured to prioritize or optimize balance parameters in a different way. For example, one algorithm (e.g., algorithm 1) may be configured to minimize or optimize weight, another algorithm (e.g., algorithm 2) may be configured to minimize or optimize static imbalance, another algorithm (e.g., algorithm 3) may be configured to minimize or optimize couple imbalance, another algorithm (e.g., algorithm 4) may be configured to minimize or optimize both static and couple imbalance by targeting a lowest possible couple imbalance while achieving a small (within a relatively small range of zero) static imbalance, still another algorithm (e.g., algorithm 5) may be configured to minimize both couple imbalance and static imbalance without prioritizing either.

Although FIG. 2 shows five different algorithms, and therefore five different strategies for optimization, it should be appreciated that either more or fewer optimization strategies could be employed in alternative embodiments. Moreover, different optimization strategies than those mentioned above could also or alternatively be employed. Thus, for example, as few as a single optimization strategy could be employed in some cases. Whereas in other cases, a multitude of distinct optimization strategies could be employed.

The operator or user may provide an algorithm selection input 210 to the balancing module 190 via the user interface 180. The balancing module 190 may, via optimization strategy selection 220, load a selected algorithm 230 based on the algorithm selection input 210. The selected algorithm 230 is the one of the candidate algorithms that corresponds to the algorithm selection input 210 selected by the operator or user via the user interface 180. The selected algorithm 230 includes the balance equations that will be loaded and applied to the data and constraints that are further provided to the balancing module 190 for use in determining a balance solution 240 as described herein. The balance solution 240 may define an amount and location for the placement of weights to correct the imbalance associated with the balance parameters 250 based on the constraints provided and the optimization strategy selected. In other words, the balance solution 240 may define a correction to apply to the rotating body 130 (defined in terms of both a magnitude of weight to apply, and a location to apply it) in order to achieve corrected balance parameters meeting a set of constraints (defined by constraint selection 260, as explained below).

However, before the balance solution 240 can be determined, the user or operator must have previously, or must now, provide additional information to the balancing module 190. In this regard, balance parameters 250 and constraint selection 260 must also be made so that the balancing module 190 can apply the selected algorithm to the balance parameters for the constraints that have been provided at operation 270. The application of the selected algorithm 230 to the constraints associated with the constraint selection 260 for a given set of the balance parameters 250 may then generate an output for the balance solution 240 that is unique to the corresponding two inputs provided (i.e., the balance parameters 250 and the constraint selection 260) for the selected algorithm 230. Changing either of the two inputs, or changing the optimization strategy (i.e., by changing the selected algorithm 230) may therefore also change the balance solution 240 accordingly. Notably, the constraint selection 260 of example embodiments may include at least one constraint that defines a non-zero target correction of at least one of the balance parameters (or both couple imbalance and static imbalance in some cases). This allows an entirely different mathematical paradigm to be employed, and vastly improves the outcomes available over conventional systems, which strictly have a zero target.

The balance parameters 250 may include information (e.g., static and couple imbalance) obtained by the balancer 110 for the rotating body 130 either currently or previously. In other words, the balance parameters 250 may define measured imbalance associated with the rotating body 130 (as measured via the balancer 110). Thus, for example, the operator or user may select the balance parameters 250 from a data set of data that was previously obtained for a particular instance of the rotating body 130. Moreover, the data set may include data associated with a plurality of different instances of the rotating body 130. For example, the data set may include data for ten wheel assemblies (or one hundred, or one thousand, . . . ). Accordingly, the operator or user may select either one or specific individual ones of the balance parameters 250 in order to determine the balance solution 240 for each individually in sequence. However, as an alternative, the operator or user may select a group of individual ones of the balance parameters 250 in order to determine the balance solution for each as a batch.

As an alternative to analyzing previously obtained data, as described above, the balance module 190 may be employed in real time (or near real time) on data obtained while the rotating body 130 is on the balancer 110. For example, the rotating body 130 may be placed on the balancer 110 and the balance parameters 250 may be obtained. The balance parameters 250 may be automatically (or by operator selection) fed to the balance module 190. The selected algorithm 230 and the constraint selection 260 may then be used to determine the balance solution 240 as described above. As noted above, the balance solution 240 may define an amount and location for the placement of weights to correct the imbalance associated with the balance parameters 250.

Of note, the provision of the information shown in FIG. 2 (i.e., each of the balance parameters 250, the constraint selection 260 and the algorithm selection input 210) may be handled in any order. Moreover, the operator or user may make manipulations to any or all of the balance parameters 250, the constraint selection 260 and the algorithm selection input 210 at any time in order to recalculate the balance solution 240. Thus, for example, the same constraints and selected algorithm could be used for different balance parameters 250 by changing the balance parameters 250 while leaving the constraint selection 260 and the algorithm selection input 210 the same. Alternatively, the same balance parameters 250 could be analyzed with the same constraint selection 260 and a different algorithm selection input 210. As another alternative, the same balance parameters 250 could be analyzed with a different constraint selection 260 and the same algorithm selection input 210. Combinations where two of the three or all three inputs are changed may also be possible.

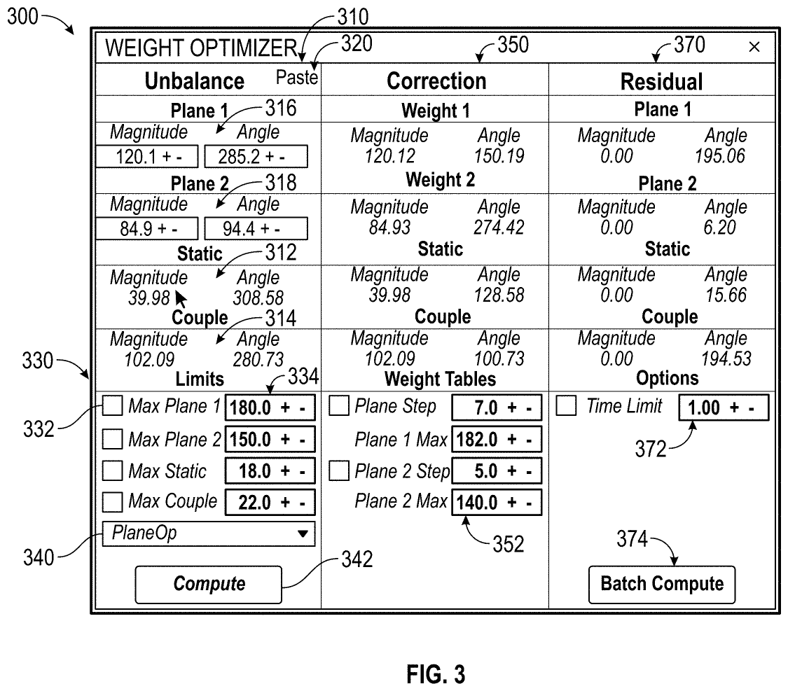

FIG. 3 illustrates an example interface screen 300 that may be used for interface with the balance module 190 of an example embodiment. Thus, for example, the interface screen 300 may be presented at the user interface 180 of FIG. 1. As shown in FIG. 1, the interface screen 300 may include an unbalance section 310 that may illustrate the balance parameters 250 that are currently being analyzed by the balance module 190. The balance parameters 250 may include values for static imbalance 312 and couple imbalance 314, and the values may include a magnitude and angle that effectively define vectors descriptive of the static and couple imbalance, respectively. The balance parameters 250 may also include vector values for imbalance measured at inboard and outboard faces of the rotating body 130 as the plane 1 imbalance 316 and plane 2 imbalance 318 values shown in FIG. 1. In an example embodiment, an operator 320 may be provided to past data into the unbalance section 310 from a database or data otherwise previously stored (e.g., in memory 172). In other words, the balance parameters 250 may be provided to the balance module 190 by selecting the operator 320 to paste data previously copied from the memory 172. However, as an alternative, the unbalance section 310 could be populated with data that is gathered currently by the balancer 110.

The interface screen 300 may further include a constraint section 330 in which various limits or constraints the can be selected by the operator or user. In other words, the constraint section 330 of FIG. 3 may be the means by which the constraint selection 260 of FIG. 2 occurs. The constraint section 330 may include, for each of a plurality of selectable limits, a selector box 332 and a value box 334. The value box 334 may be used to define a corresponding amount or value that is to be associated with each selectable limit, and the selector box 332 is either checked (in order to select the corresponding selectable limit to be applied) or unchecked (in order to leave the corresponding selectable limit unapplied).

The selectable limits shown in FIG. 3 include a maximum value (in g) for plane 1, plane 2, static imbalance and couple imbalance. However, other values could be defined for other example embodiments. When a given selectable limit is to be applied (i.e., selected), the balance module 190 will apply the corresponding selectable limit to the balance equations that are used for the selected algorithm 230. The selected algorithm 230 can be selected via the algorithm selector 340.

Thus, by inputting the balance parameters 250 in the unbalance section 310, by inputting the constraint selection 260 in the constraint section 330, and by selecting the optimization strategy to be used (i.e., selecting the selected algorithm 230) via the algorithm selector 340, the balance module 190 is ready to compute the balance solution 240. The compute selector 342 may be selected to perform the computation using the selected algorithm 230 and the constraint selection 260 for the balance parameters 250.

The balance solution 240 may include correction data and resultant balance data. The correction data may be provided in a correction section 350 of the interface screen 300. The correction section 350 may include information identifying a magnitude and location for weights to be placed in order to achieve the resultant balance data that may be provided in resultant data section 370 on the interface screen 300. The resultant data section 370 may provide resultant balance measurements for plane 1, plane 2, static imbalance and couple imbalance assuming the correction data from the correction section 350 is applied to the rotating body 130.

In some cases, weight tables 352 may be provided in the correction section 350. The weight tables 352 may be used to select a maximum allowed weight and/or the step size for adding weights to either the outboard face or inboard face (i.e., planes 1 and 2). In some embodiments, the resultant data section 370 may also include a time limit selector 372. The time limit selector 372 may be used to define a maximum time that the balance module 190 is enabled to use for making determinations regarding the balance solution 240. In this regard, since the balance equations used for some balance parameters 250 and constraint selection 260 for a given selected algorithm 230 may require iterative calculations that search for a convergence to determine an answer, it may be desirable to limit the time allotted for such convergence to occur.

In some embodiments, the interface screen 300 may also include a batch compute selector 374. The batch compute selector 374 may be used when a plurality of calculations for a corresponding plurality of instances of the balance parameters 250 (using one set of constraint selection 260 and selected algorithm 230 variables) are desired. In such an example, the operator or user may select all of the data that is to be used as respective instances of the balance parameters 250. The operator or user may then select the constraint selection 260 (via the constraint section 330) and the selected algorithm 230 (via the algorithm selector 340). Then, by selecting the batch compute selector 374, the balance module 190 may calculate the balance solution 240 for each of the individual instances of the balance parameters 250. The outputs may be sequentially shown in the interface screen 300, or may be output to a table for later use or viewing.

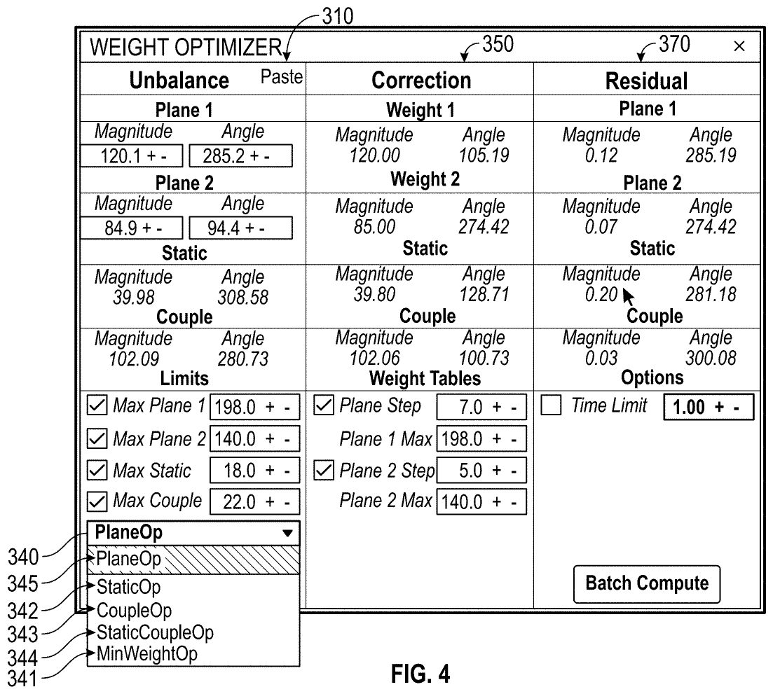

FIG. 4 illustrates an example in which the algorithm selector 340 operates as a menu of selectable options including a first algorithm 341 configured to minimize or optimize weight, a second algorithm 342 configured to minimize or optimize static imbalance, a third algorithm 343 configured to minimize or optimize couple imbalance, a fourth algorithm 344 configured to minimize or optimize both static and couple imbalance by targeting a lowest possible couple imbalance while achieving a small (within a relatively small range of zero) static imbalance, and a fifth algorithm 345 configured to minimize both couple imbalance and static imbalance without prioritizing either. Referring still to FIG. 4, it can be seen that the selected algorithm 230 is the fifth algorithm 245. Thus, the values listed in the correction section 350 demonstrate correction data that can be used for the balance parameters 250 shown in the unbalance section 310 in order to minimize both the static and couple imbalance (as shown in the resultant data section 370) without prioritizing either.

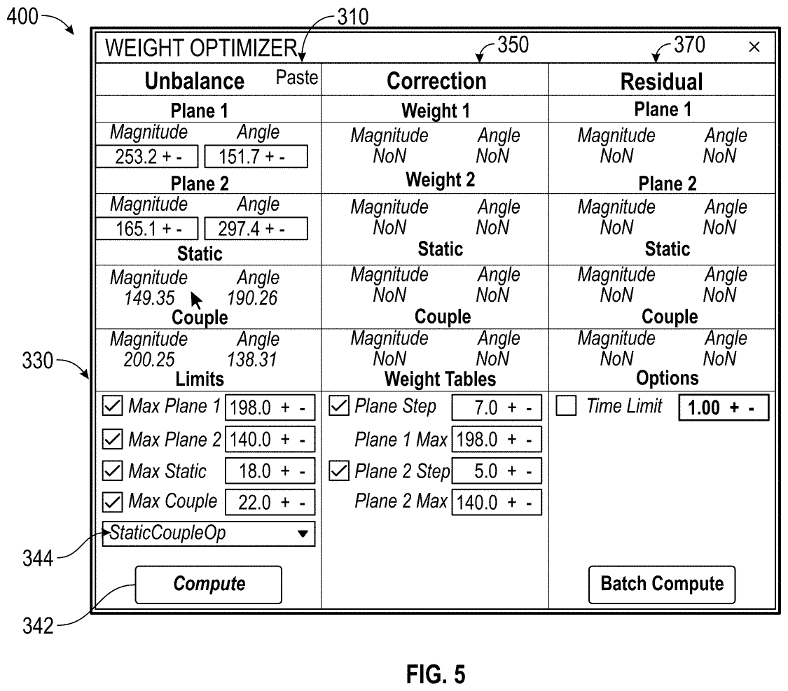

As noted above, any or all of the selected algorithm 230, the balance parameters 250 or the constraint selection 260 could be changed, and the balance module 190 may recalculate the balance solution 240. The changes may be initiated to any or all of the variables and then the compute selector 342 may be selected to perform the corresponding computations (e.g., using the balance equations stored in association with the selected algorithm 230, and using the balance parameters 250 and constraint selection 260 provided). FIGS. 5-7 illustrate some changes that may be experienced when conducting these selections in accordance with an example embodiment.

In this regard, for example, FIG. 5 illustrates an interface screen 400 for a given set of data provided as the balance parameters 250 and shown in the unbalance section 310. The constraint selection 260 has also been made in the constraint section 330. The selected algorithm 230 for this example is the fourth algorithm 344, which is configured to minimize or optimize both static and couple imbalance by targeting a lowest possible couple imbalance while achieving a small (within a relatively small range of zero) static imbalance. For this set of constraint selection 260 and balance parameters 250, no balance solution is possible. Thus, as can be seen in FIG. 5, the correction section 350 and the resultant data section 370 do not show any results.

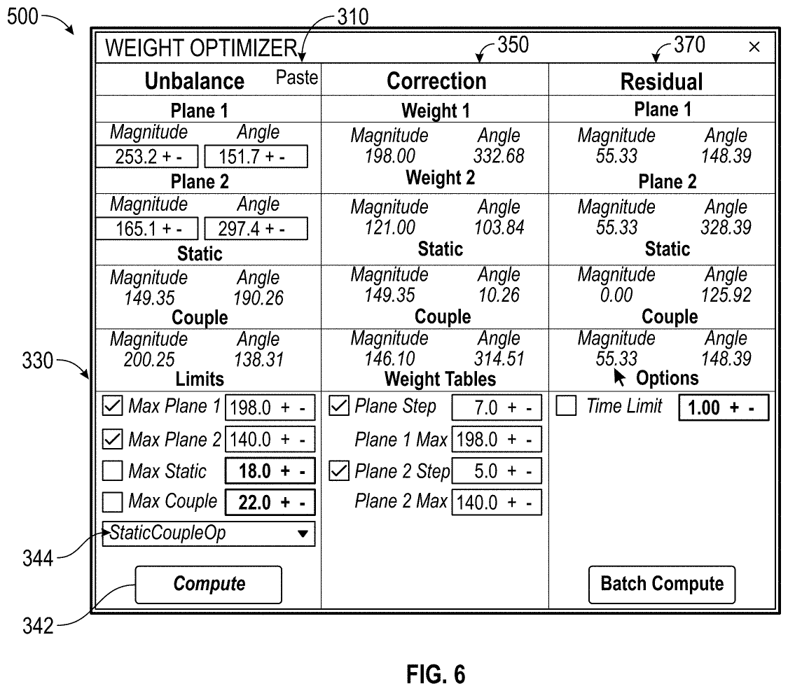

In FIG. 6, the limit on maximum couple imbalance and the limit on maximum static imbalance been removed from the constraint section 330. However, no other changes are made for interface screen 500 of FIG. 6 relative to that of interface screen 400 of FIG. 5. By eliminating the constraints on maximum static and couple imbalance, even using the same algorithm (with all other parameters and inputs unchanged), a solution is now possible as shown in the correction section 350 and the resultant data section 370 of FIG. 6.

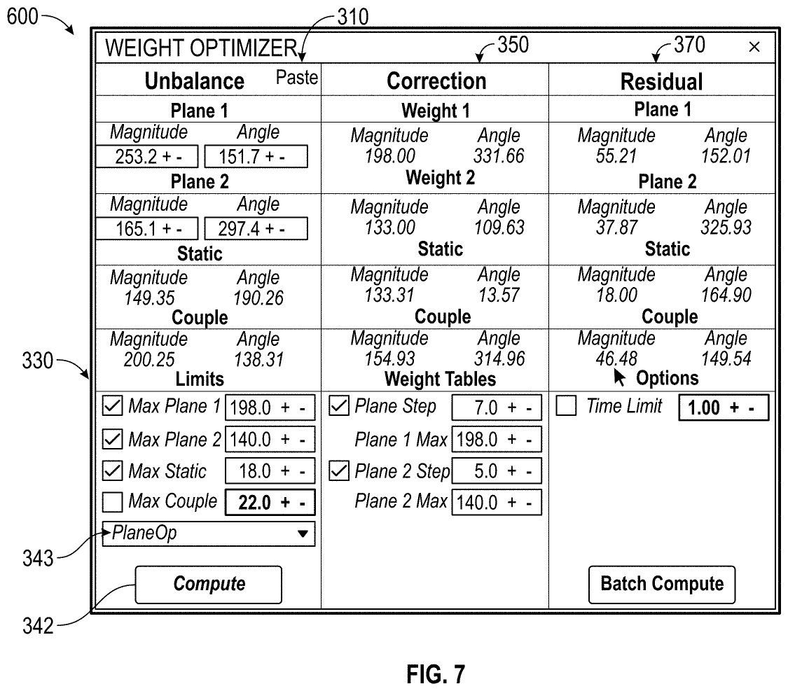

In FIG. 7, the limit on maximum couple imbalance has been removed from the constraint section 330 (relative to FIG. 5), and the selected algorithm 230 is the third algorithm 343. By eliminating the constraint on maximum couple imbalance, and by using a different algorithm (with all other parameters and inputs unchanged relative to the example of FIG. 5), a solution is now possible as shown in the correction section 350 and the resultant data section 370 of the interface screen 600 of FIG. 7.

Thus, the examples of FIGS. 5, 6 and 7 illustrate the flexibility that an operator or user has to find solutions that work for generating the balance solution 240. Moreover, these examples demonstrate how the operator or user can make changes to individual constraints or the optimization algorithm, on the fly, in order to find solutions that may work best for a given part, or even for a given plant. In this regard, for example, one plant may be using a particular wheel assembly that is to be installed on a first type of vehicle, and another plant may be using the particular wheel assembly for installation on a second type of vehicle. In these cases, the same wheel assembly can be balanced with different priorities and with different correction strategies that vary on a plant to plant basis.

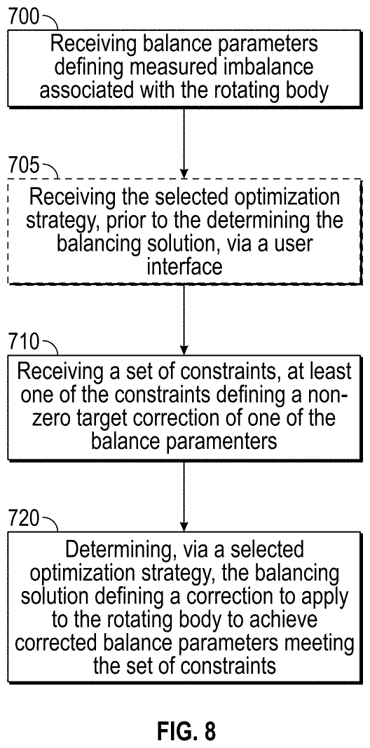

From a technical perspective, the balance module 190 described above may be used to support various operations associated with an application or method for determining a balance solution for a rotating body. As such, the platform described in FIG. 1 may be used to facilitate the implementation of several computer programs. As an example, FIG. 8 is an example of a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart of FIG. 8 support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions. The method of FIG. 8 may include receiving balance parameters defining measured imbalance associated with the rotating body at operation 700. The method may further include receiving a set of constraints at operation 710. Within this context, at least one of the constraints may define a non-zero target correction of one of the balance parameters. The method may also include determining, via a selected optimization strategy, the balancing solution defining a correction to apply to the rotating body to achieve corrected balance parameters meeting the set of constraints at operation 720.

In an example embodiment, an apparatus (e.g., the balance module 190) for performing the method of FIG. 8 above may comprise a processor (e.g., the processor 170) or processing circuitry configured to perform some or each of the operations (700-720) described above. The processor may, for example, be configured to perform the operations (700-720) by performing hardware implemented logical functions, executing stored instructions, or executing algorithms for performing each of the operations. In some embodiments, the processor or processing circuitry may be further configured for the additional operations or optional modifications to operations 700-720 that are discussed below.

The method (or apparatus configure to perform the method) of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the method may further include optional operation 705 (shown in dashed lines), which includes receiving the selected optimization strategy from a user, prior to the determining the balancing solution, via a user interface. Of note, operations 700, 705 and 710 can be performed in any order. In an example embodiment, the selected optimization strategy may include a selected algorithm defined by corresponding balance equations, where the selected algorithm is one of a plurality of predefined algorithms. In some cases, the plurality of predefined algorithms may include a first algorithm configured to minimize weight, a second algorithm configured to minimize static imbalance, a third algorithm configured to minimize couple imbalance, a fourth algorithm configured to minimize both static and couple imbalance while prioritizing a lowest static imbalance, and a fifth algorithm configured to minimize both couple imbalance and static imbalance without prioritizing static imbalance or couple imbalance. In an example embodiment, receiving the set of constraints may include receiving individually selectable limits for the corrected balance parameters. In some cases, receiving the individually selectable limits may include receiving an individually selectable maximum static imbalance value and an individually selectable maximum couple imbalance value. In an example embodiment, receiving the set of constraints may include receiving a step value for correction weights and a maximum value for weight correction. In some cases, the step value for correction weights and the maximum value for weight correction may be individually applicable to each of an inboard face of the rotating body and an outboard face of the rotating body. In an example embodiment, a plurality of balance parameters for a corresponding plurality of rotating bodies may be selectable for batch computation of balancing solutions using the set of constraints and the selected optimization strategy.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A method of determining a balancing solution for a rotating body comprising a wheel or wheel assembly, the method comprising:
receiving balance parameters defining measured imbalance associated with the rotating body;
receiving a set of constraints, at least one of the constraints defining a non-zero target correction of one of the balance parameters; and
determining, via a selected optimization strategy, the balancing solution defining a correction to apply to the rotating body to achieve corrected balance parameters meeting the set of constraints.

2. The method of claim 1, further comprising receiving the selected optimization strategy, prior to the determining the balancing solution, via a user interface.

3. The method of claim 2, wherein the selected optimization strategy comprises a selected algorithm defined by corresponding balance equations, the selected algorithm being one of a plurality of predefined algorithms.

4. The method of claim 3, wherein the plurality of predefined algorithms comprise:
a first algorithm configured to minimize weight;
a second algorithm configured to minimize static imbalance;
a third algorithm configured to minimize couple imbalance;
a fourth algorithm configured to minimize both static and couple imbalance while prioritizing a lowest static imbalance; and
a fifth algorithm configured to minimize both couple imbalance and static imbalance without prioritizing static imbalance or couple imbalance.

5. The method of claim 1, wherein receiving the set of constraints comprises receiving individually selectable limits for the corrected balance parameters.

6. The method of claim 5, wherein receiving the individually selectable limits comprises receiving an individually selectable maximum static imbalance value and an individually selectable maximum couple imbalance value.

7. The method of claim 1, wherein receiving the set of constraints comprises receiving a step value for correction weights and a maximum value for weight correction.

8. The method of claim 7, wherein the step value for correction weights and the maximum value for weight correction are individually applicable to each of an inboard face of the rotating body and an outboard face of the rotating body.

9. The method of claim 1, wherein a plurality of balance parameters for a corresponding plurality of rotating bodies are selectable for batch computation of balancing solutions using the set of constraints and the selected optimization strategy.

10. A balance controller for determining a balancing solution for a rotating body comprising a wheel or wheel assembly, the balance controller comprising processing circuitry configured to:
receive balance parameters defining measured imbalance associated with the rotating body;
receive a set of constraints, at least one of the constraints defining a non-zero target correction of one of the balance parameters; and
determine, via a selected optimization strategy, the balancing solution defining a correction to apply to the rotating body to achieve corrected balance parameters meeting the set of constraints.

11. The balance controller of claim 10, wherein the processing circuitry is further configured to receive the selected optimization strategy, prior to the determining the balancing solution, via a user interface.

12. The balance controller of claim 11, wherein the selected optimization strategy comprises a selected algorithm defined by corresponding balance equations, the selected algorithm being one of a plurality of predefined algorithms.

13. The balance controller of claim 12, wherein the plurality of predefined algorithms comprise:
a first algorithm configured to minimize weight;
a second algorithm configured to minimize static imbalance;
a third algorithm configured to minimize couple imbalance;
a fourth algorithm configured to minimize both static and couple imbalance while prioritizing a lowest static imbalance; and
a fifth algorithm configured to minimize both couple imbalance and static imbalance without prioritizing static imbalance or couple imbalance.

14. The balance controller of claim 10, wherein receiving the set of constraints comprises receiving individually selectable limits for the corrected balance parameters.

15. The balance controller of claim 14, wherein receiving the individually selectable limits comprises receiving an individually selectable maximum static imbalance value and an individually selectable maximum couple imbalance value.

16. The balance controller of claim 10, wherein receiving the set of constraints comprises receiving a step value for correction weights and a maximum value for weight correction.

17. The balance controller of claim 16, wherein the step value for correction weights and the maximum value for weight correction are individually applicable to each of an inboard face of the rotating body and an outboard face of the rotating body.

18. The balance controller of claim 10, wherein a plurality of balance parameters for a corresponding plurality of rotating bodies are selectable for batch computation of balancing solutions using the set of constraints and the selected optimization strategy.

19. A balancing system for determining a balancing solution for a rotating body comprising a wheel or wheel assembly, the balancing system comprising:
a balancer comprising a motor and spindle for rotating the rotating body, and one or more sensors configured to determine balance parameters defining measured imbalance associated with the rotating body; and
a balance controller comprising processing circuitry configured to:
receive the balance parameters,
receive a set of constraints, at least one of the constraints defining a non-zero target correction of one of the balance parameters, and
determine, via a selected optimization strategy, the balancing solution defining a correction to apply to the rotating body to achieve corrected balance parameters meeting the set of constraints.

20. The balancing system of claim 19, wherein the processing circuitry is further configured to receive the selected optimization strategy, prior to the determining the balancing solution, via a user interface associated with the balance controller.
